(19) United States
(12) Patent Application Publication
(10) Pub. No.: US 2025/0012964 A1
(43) Pub. Date: Jan. 9, 2025

(54) DISPLAY DEVICE

(71) Applicant: Japan Display Inc., Tokyo (JP)

(72) Inventor: Tenfu NAKAMURA, Tokyo (JP)

(73) Assignee: Japan Display Inc., Tokyo (JP)

(21) Appl. No.: 18/764,615

(22) Filed: Jul. 5, 2024

(30) Foreign Application Priority Data
Jul. 7, 2023 (JP) 2023-112442

(51) Int. Cl. F21V 8/00; G02F 1/1334; G02F 1/13357

(52) U.S. Cl. CPC G02B 6/0046; G02B 6/0068; G02F 1/1334; G02F 1/1336

(57) ABSTRACT

According to one embodiment, a display device includes a display panel having a liquid crystal layer containing a polymer dispersion liquid crystal, and a light guide element. The light guide element includes a base, a transparent layer having a refractive index lower than a refractive index of the base. A plurality of light emitting elements are arranged adjacent to a first side surface of the base, the first thickness of the transparent layer decreases from the first side surface towards a second side surface on an opposite side to the first side, and the second thickness of the transparent adhesive layer increasing from the first side surface towards the second side surface.

### CROSS-REFERENCE TO RELATED APPLICATIONS

This application is based upon and claims the benefit of priority from Japanese Patent Application No. 2023-112442, filed Jul. 7, 2023, the entire contents of which are incorporated herein by reference.

### FIELD

Embodiments described herein relate generally to a display device.

### BACKGROUND

Display devices that can switch between a scattering state, in which incident light is scattered, and a transmission state, in which incident light is transmitted, using polymer dispersed liquid crystal (PDLC) have been proposed. For transparent display devices using PDLC, an edge light mode is adopted, in which a light source is disposed in an end portion of the light guide. However, when the edge light mode is used for PDLC display devices, there is conventionally a drawback that the brightness of the display surface decreases as the distance from the light source increases.

As a solution to such a drawback, such display devices have been developed in which a light guide element including a transparent layer having a low refractive index, formed in a shape of an isosceles triangle is provided on the liquid crystal panel.

However, these display devices entail a new drawback that moiré may occur between the isosceles triangle-shaped transparent layer and pixels.

### BRIEF DESCRIPTION OF THE DRAWINGS

FIG. 1 is a plan view schematically showing a configuration of a display device of an embodiment.

FIG. 2 is a cross-sectional view schematically showing a configuration of a display panel shown in FIG. 1.

FIG. 3 is an exploded perspective view showing a main part of the display device.

FIG. 4 is a cross-sectional view schematically showing a configuration example of the display device.

FIG. 5 is a cross-sectional view schematically showing a configuration example of the display device.

FIG. 6 shows a result of simulation indicating a relationship between thickness and reflectance of a material layer with a low refractive index.

FIG. 7 is a diagram showing the relationship between the reflectance and the thickness when the thickness is 300 nm, 600 nm, 800 nm, and 1000 nm in the simulation results shown in FIG. 6.

FIG. 8 is a diagram showing a relationship between wavelength (λ) of light ([nm]), incident angle of light ([°]), and transmittance.

FIG. 9 is a diagram showing a relationship between the thickness of a transparent layer and the transmittance.

FIG. 10 is a diagram showing the relationship between the thickness of the transparent layer and the transmittance, obtained based on the relationship of FIG. 9.

FIG. 11 is a cross-sectional view schematically showing a configuration example of the transparent layer.

### DETAILED DESCRIPTION

In general, according to one embodiment, a display device comprises
a display panel comprising a first substrate, a second substrate, a liquid crystal layer containing a polymer dispersion liquid crystal;
a plurality of light emitting elements; and
a light guide element,
the light guide element comprising:
a base;
a transparent layer having a refractive index lower than a refractive index of the base; and
a transparent adhesive layer provided to overlap the transparent layer, wherein
the plurality of light emitting elements are arranged adjacent to a first side surface of the base,
a first thickness of the transparent layer decreases from the first side surface towards a second side surface on an opposite side to the first side, and
a second thickness of the transparent adhesive layer increases from the first side surface towards the second side surface.

An object of this embodiment is to provide a display device in which the brightness of images is uniform and the occurrence of moiré can be suppressed.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90°. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment

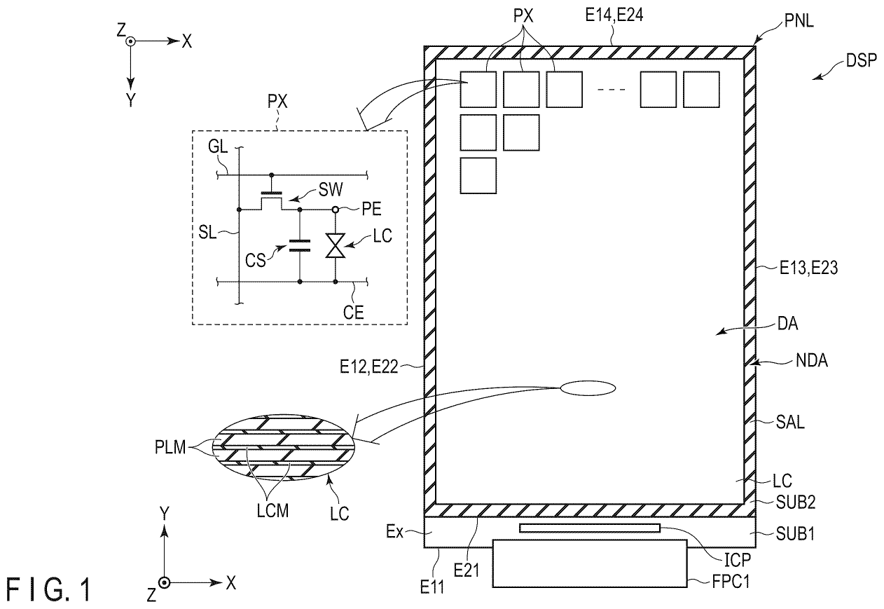

FIG. 1 is a plan view schematically showing a configuration of a display device of an embodiment.

In this embodiment, as an example of a display device DSP, a liquid crystal display device in which polymer dispersed liquid crystal is applied will be described. The display device DSP comprises a display panel PNL, an IC chip ICP, and a wiring board FPC1.

The display panel PNL comprises a substrate SUB1, a substrate SUB2, a liquid crystal layer LC, and a seal SAL. The substrate SUB1 and the substrate SUB2 are each formed into a flat plate parallel to the X-Y plane. The substrate SUB1 and the substrates SUB2 overlap each other in plan view. The substrate SUB1 and the substrate SUB2 are attached together by a seal SAL. The liquid crystal layer LC is held between the substrate SUB1 and the substrate SUB2 and sealed therein by the seal SAL.

As shown schematically in enlarged form in FIG. 1, the liquid crystal layer LC comprises polymer dispersed liquid crystal containing polymers PLM and liquid crystal molecules LCM. For example, the polymers PLM are liquid crystalline polymers. The polymers PLM are formed in a stripe shape extending along the first direction X. The liquid crystal molecules LCM are dispersed in gaps between the polymers PLM and are aligned such that their longitudinal axes are along the first direction X. Each of the polymers PLM and the liquid crystal molecules LCM has an optical anisotropy or refractive index anisotropy. The responsivity of the polymers PLM to an electric field is lower than that of the liquid crystal molecules LCM to the electric field.

For example, the alignment direction of the polymers PLM does not substantially changes regardless of the presence/absence of an electric field. On the other hand, the alignment direction of the liquid crystal molecules LCM changes in response to an electric field when a voltage higher than or equal to the threshold is being applied to the liquid crystal layer LC. When no voltage is applied to the liquid crystal layer LC, the respective optical axes of the polymers PLM and the liquid crystal molecules LCM are parallel to each other, and light entering the liquid crystal layer LC is transmitted therethrough (transparent state) without being substantially scattered in the liquid crystal layer LC. When voltage is applied to the liquid crystal layer LC, the respective optical axes of the polymers PLM and the liquid crystal molecules LCM cross each other, and light entering the liquid crystal layer LC is scattered within the liquid crystal layer LC (scattered state).

The display panel PNL comprises a display area DA for displaying images and a frame-like non-display area NDA surrounding the display area DA. The seal SAL is located in the non-display area NDA. The display area DA comprises pixels PX arranged in a matrix along the first direction X and the second direction Y.

As shown enlarged in FIG. 1, each of the pixels PX comprises a switching element SW, a pixel electrode PE, a common electrode CE, a liquid crystal layer LC, and the like. The switching element SW is constituted by a thin-film transistor (TFT), for example, and is electrically connected to a respective scanning line GL and a respective signal line SL.

Although not illustrated in the figure, a plurality of scanning lines GL extended along the first direction X and arranged side by side along the second direction Y. As shown in FIG. 1, one scanning line GL is electrically connected to the switching element SW in each of the pixels PX aligned along the first direction X.

Although not illustrated in the figure, a plurality of signal lines SL extend along a direction parallel to the second direction Y and are arranged side by side along the first direction X. As shown in FIG. 1, one signal line SL is electrically connected to the switching element SW in each of the pixels PX aligned along the second direction Y. The signal lines SL intersect the scanning lines GL.

Each of the pixels PX occupies the area compartmentalized by a respective adjacent pair of signal lines SL and a respective adjacent pair of scanning lines GL. That is, the plurality of pixels PX are arranged at a predetermined pitch along each of the first direction X and the second direction Y. The pitch of the pixels PX arranged along the first direction X is equal to the pitch of the signal lines SL. The pitch of the pixels PX arranged along the second direction Y is equal to the pitch of the scanning lines GL.

The pixel electrodes PE are electrically connected to the switching elements SW, respectively. Each of the pixel electrodes PE opposes the common electrode CE, and the liquid crystal layer LC (in particular, liquid crystal molecules LCM) is driven by the electric field produced between the pixel electrode PE and the common electrode CE.

The scanning lines GL, the signal lines SL, the switching elements SW, and the pixel electrodes PE are provided on the substrate SUB1. A capacitor CS is formed, for example, between an electrode of the same potential as that of the common electrode CE and an electrode of the same potential as that of the respective pixel electrode PE.

The substrate SUB1 includes an end portion E11 and an end portion E14, which extend along the first direction X, and an end portion E12 and an end portion E13, which extend along the second direction Y. The substrate SUB2 includes an end portion E21 and an end portion E24, which extend along the first direction X, and an end portion E22 and an end portion E23, which extend along the second direction Y.

In the example illustrated in FIG. 1, the end portion E12 and the end portion E22 overlap each other in plan view, and so do the end portion E13 and the end portion E23, and the end portion E14 and the end portion E24, but may not be arranged to overlap. The end portion E21 is located between the end portion E11 and the display area DA in plan view. The substrate SUB1 includes an extended region Ex between the end portion E11 and the end portion E21.

The IC chip ICP and the circuit board FPC1 are each connected to the extended region Ex. The IC chip ICP contains, for example, a display driver built therein that outputs signals necessary for image display. The wiring board FPC1 is a flexible printed circuit board that can be bent. Note that the IC chip ICP may be connected to the wiring board FPC1. The IC chip ICP and the wiring board FPC1 read out signals from the display panel PNL in some cases, but function mainly as signal sources that supply signals to the display panel PNL.

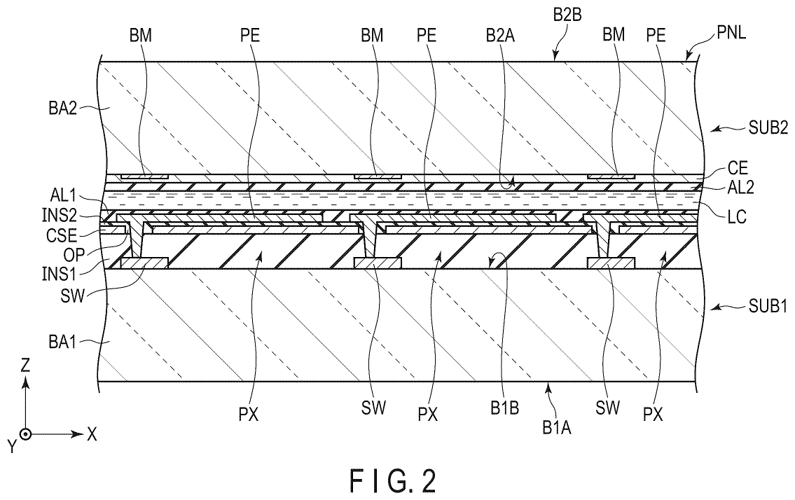

FIG. 2 is a cross-sectional view schematically showing a configuration of the display panel shown in FIG. 1.

The substrate SUB1 comprises a base BA1, an insulating layer INS1, an insulating layer INS2, a capacitive electrode CSE, a switching element SW, a pixel electrode PE, and an alignment film AL1. The substrate SUB1 further comprises the scanning lines GL and signal lines SL shown in FIG. 1.

The base BA1 is formed of a translucent material. The base BA1 comprises a main surface (lower surface) B1A and a main surface (upper surface) B1B on an opposite side to the main surface B1A. The switching elements SW are disposed on the main surface B1B.

The insulating layer INS1 covers the switching elements SW. The capacitive electrode CSE is located between the insulating layer INS1 and the insulating layer INS2. The pixel electrode PE is provided for each pixel PX on the insulating layer INS2. The pixel electrode PE is electrically connected to the switching element SW via an opening OP formed in the capacitive electrode CSE. The pixel electrode PE overlaps the capacitive electrode CSE while interposing the insulating layer INS2 therebetween to form the capacitor CS of the pixel PX. The alignment film AL1 covers the pixel electrode PE.

The substrate SUB2 comprises a base BA2, a light-shielding layer BM, a common electrode CE, and an alignment film AL2.

The base BA2 is formed of a translucent material. The base BA2 comprises a main surface (lower surface) B2A and a main surface (upper surface) B2B on an opposite side to the main surface B2A. The main surface B2A of the base BA2 opposes the main surface B2B of the base BA1. The light-shielding layer BM and the common electrode CE are disposed on the main surface B2A. The light-shielding layer BM is located, for example, directly above the switching element SW and directly above the scanning line GL and the signal line SL, which are not shown in the figure.

The common electrode CE is located over a plurality of pixels PX and directly covers the light-shielding layer BM. The common electrode CE opposes the pixel electrode PE. The common electrode CE is electrically connected to the capacitive electrode CSE and is at the same potential as that of the capacitive electrode CSE. The alignment film AL2 covers the common electrode CE. The liquid crystal layer LC is located between the main surface B1B and the main surface B2A and is in contact with the alignment film AL1 and the alignment film AL2.

The base BA1 and the base BA2 are insulating base materials such as glass or plastic. The main surface B1A, main surface B1B, main surface B2A, and main surface B2B are planes substantially parallel to the X-Y plane.

The insulating layer INS1 is formed of a transparent insulating material such as silicon oxide, silicon nitride, silicon oxynitride, acrylic resin or the like. For example, the insulating layer INS1 includes an inorganic insulating layer and an organic insulating layer. The insulating layer INS2 is an inorganic insulating layer such as of silicon nitride.

The capacitive electrode CSE, the pixel electrode PE, and the common electrode CE are transparent electrodes formed from a transparent conductive material such as indium tin oxide (ITO) or indium zinc oxide (IZO).

The light-shielding layer BM is, for example, a conductive layer having a resistance lower than that of the common electrode CE. For example, the light-shielding layer BM is formed of an opaque metal material such as molybdenum (Mo), aluminum (Al), tungsten (W), titanium (Ti), silver (Ag) or the like.

The alignment film AL1 and the alignment film AL2 are horizontal alignment films having an alignment restriction force that is substantially parallel to the X-Y plane. For example, the alignment film AL1 and the alignment film AL2 are subjected to alignment treatment along the first direction X. The alignment treatment may be a rubbing treatment or a photo-alignment treatment.

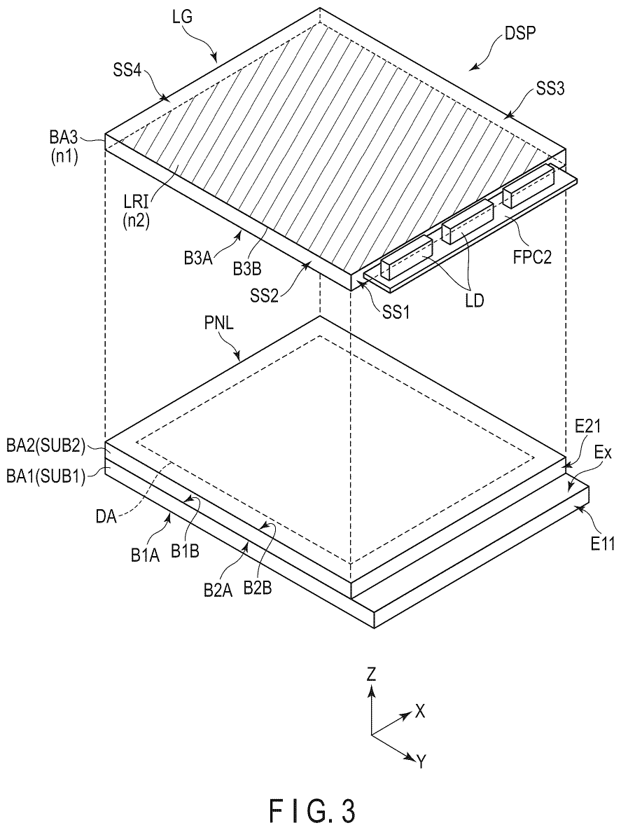

FIG. 3 is an exploded perspective view showing a main part of the display device.

The display device DSP comprises a plurality of light emitting elements LD and a light guiding element LG in addition to the display panel PNL. The substrate SUB1, the substrate SUB2, and the light guiding element LG are arranged side by side in this order along the third direction Z.

The plurality of light emitting elements LD are arranged to be spaced apart from each other along the first direction X. The plurality of light emitting elements LD are connected to the wiring board FPC2. The light emitting elements LD are, for example, light emitting diodes. The light emitting elements LD comprise a red light emitting element, a green light emitting element, and a blue light emitting element, which will not be described in detail though. The light emitted from the light emitting elements LD proceeds along the direction of the arrow indicating the second direction Y.

The light guide element LG comprises a base BA3 and a transparent layer LRI.

The base BA3 is formed of a translucent material. The base BA3 is an insulating base material such as glass or plastic and has a refractive index n1. For example, the base BA3 is a single base material, rather than a plurality of base materials bonded together.

The base BA3 comprises a main surface (lower surface) B3A, a main surface (upper surface) B3B on an opposite side to the main surface B3A, a first side surface SS1, a second side surface SS2, a third side surface SS3, and a fourth side surface SS4. The main surface B3A and the main surface B3B are planes substantially parallel to the X-Y plane. The main surface B3A opposes the main surface B2B of the base BA2.

The first side surface SS1 opposes a plurality of light emitting elements LD. The first side surface SS1 and the fourth side surface SS4 extend along the first direction X. The second side surface SS2 and the third side surface SS3 extend along the second direction Y. The first side surface SS1 and the fourth side surface SS4 oppose each other. The second side surface SS2 and the third side surface SS3 oppose each other. The second side surface SS2 and the third side surface SS3 intersect the first side surface SS1.

The base BA3 is adhered to the base BA2 while interposing the transparent layer LRI therebetween, as will be described later. In the example illustrated in FIG. 3, the first side surface SS1 is located directly above the end portion E21 of the substrate SUB2, but it may be located directly above the stretched region Ex or on a further outer side with respect to the end portion E11.

The transparent layer LRI is disposed over the main surface B3A. The transparent layer LRI is the so-called solid film. But, the thickness of the transparent layer LRI varies from the first side surface SS1 to the fourth side surface SS4. The details of the thickness of the transparent layer LRI will be described later.

The base BA3 is formed, for example, of glass or an organic material such as polymethyl methacrylate (PMMA) or polycarbonate (PC). The transparent layer LRI is formed, for example, from an organic material such as siloxane-based resin or fluorinated resin. The transparent layer LRI has a refractive index n2 lower than the refractive index n1 of the base BA3. The refractive index n1 of the base BA3 is about 1.5, and the refractive index n2 of the transparent layer LRI is about 1.0 to 1.4.

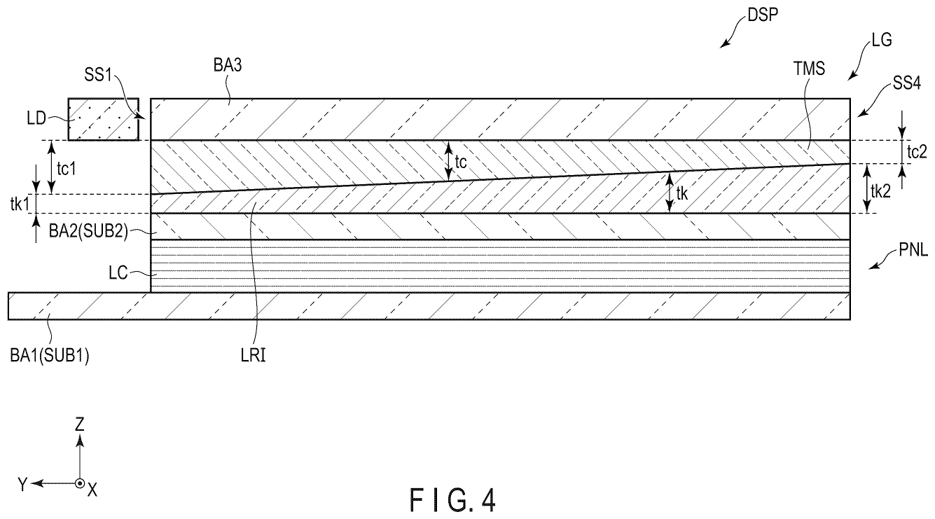

FIG. 4 is a cross-sectional view schematically showing an example of the configuration of the display device. In the display device DSP of FIG. 4, only the components necessary for explanation are shown.

A stacked body of a transparent layer LRI and a transparent adhesive layer TMS is provided between the base BA2 and the base BA3. Here, the thickness of the transparent layer LRI is referred to as a thickness tc. The thickness tc increases from the first side surface SS1 towards the fourth side surface SS4. The thicknesses tc at the first side surface SS1 and the fourth side surface SS4 are defined as a thickness tc1 and a thickness tc2, respectively. The thickness tc2 is greater than the thickness tc1 (tc2>tc1).

Here, the thickness of the transparent adhesive layer TMS is referred to as a thickness tk, and the thickness tk decreases from the first side surface SS1 towards the fourth side surface SS4. The thicknesses tk at the first side surface SS1 and the fourth side surface SS4 are referred to as a thickness tk1 and a thickness tk2, respectively. The thickness tk2 is less than the thickness tk1 (tc2<tc1).

The sum of the thickness tc of the transparent layer LRI and the thickness tk of the transparent adhesive layer TMS is constant over the first side surface SS1 and the fourth side surface SS4. In other words, the gap between the display panel PNL and the base BA3 is constant.

Here, the function of the transparent layer LRI will now be explained. The transparent layer LRI has the function of guiding the light emitted from the light emitting element LD and entering the first side surface SS1 to a fourth side surface SS4 side.

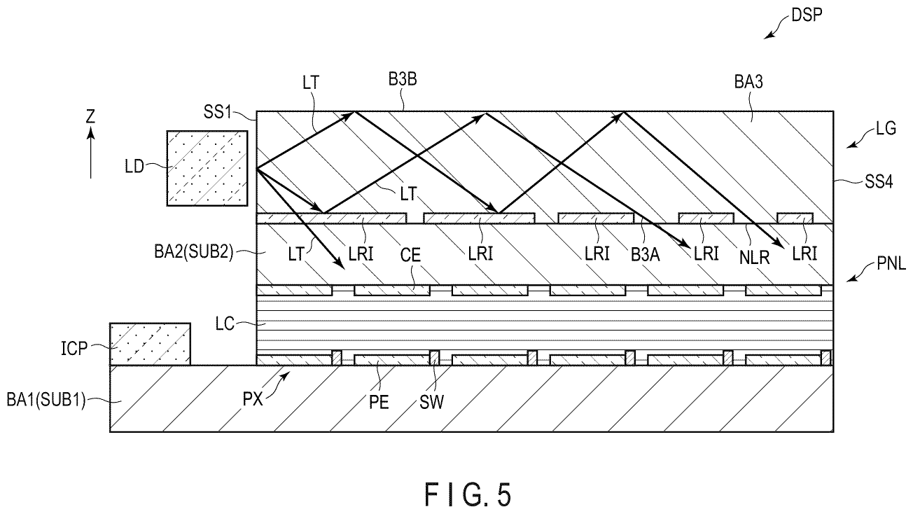

FIG. 5 is a diagram schematically showing a cross-sectional configuration of an example of the configuration of the display device. In the display device DSP shown in FIG. 5, the density of the transparent layer LRI changes according to the distance from the light emitting element LD. The details thereof will now be explained.

Light LT emitted from the light emitting elements LD enters the first side surface SS1 of the base BA3. The light LT entering the first side surface SS1 is guided inside the base BA3 by being reflected by the main surface B3B and the transparent layer LRI. The main surface B3B is the interface between the base BA3 and the air layer.

As described above, the light LT is reflected by the main surface B3B and the transparent layer LRI. But when it passes through a region NLR of the main surface B3A, where the transparent layer LRI is not provided, it enters the display panel PNL through the region NLR. Note that the light LT may as well enter the display panel PNL through the transparent layer LRI in some cases.

By being reflected at the transparent layer LRI, the light LT can be guided from the first side surface SS1, which is the incident surface, to the fourth side surface SS4, which opposes the first side surface SS1. The light LT entering the display panel PNL in the region NLR is diffused or transmitted by the liquid crystal layer LC of the display panel PNL. In this manner, images are displayed on the display device DSP.

The density of the transparent layer LRI is varied according to the distance from the light emitting elements LD. More specifically, as the location is closer to the light emitting elements LD, the area of the transparent layer LRI is larger. With this configuration, in a region closer to the light emitting elements LD, the amount of the light LT reflected by the transparent layer LRI is greater than the amount of the light LT entering the display panel PNL.

On the other hand, as discussed above, in a region far from the light emitting element LD, the area of the transparent layer LRI is smaller. With this configuration, in the region far from the light emitting elements LD, the amount of the light LT entering the display panel PNL is greater than the amount of the light LT reflected by the transparent layer LRI.

In order to change the area of the transparent layer LRI, it is preferable to provide the transparent layer LRI as triangular-shaped band portions BND. Here, the bottom edge of the triangle is placed in the region close to the light emitting elements LD, and the vertex of the triangle is placed in the region far from the light emitting elements LD.

With the above-described configuration, it is possible to guide the light LT to the region far from the light emitting element LD, and the brightness of the images displayed on the display device DSP can be made uniform.

However, as mentioned above, a new drawback has arisen, that is, moiré occurs between the transparent layer LRI and the pixels PX.

Under these circumstances, in this embodiment, as shown in FIG. 4, the transparent layer LRI is formed as the so-called solid film, and the thickness tc of the transparent layer LRI is decreased as the location becomes farther from the light emitting element LD. With this configuration, the same effect as that obtained when varying the area of the transparent layer LRI to be obtained. Further, since the transparent layer LRI is a solid film, moiré does not occur. In the above-described manner, the display device DSP of this embodiment can not only make the brightness of the displayed images uniform, but also suppress the occurrence of moiré.

As described above, the refractive index of the transparent layer LRI is lower than that of the base BA3. When electromagnetic waves are totally reflected between materials having such a difference in refractive index, such a phenomenon occurs that electromagnetic waves penetrate out from a material with a high refractive index to a material with a low refractive index. The penetrating electromagnetic wave is called evanescent wave. When the electromagnetic wave is light, it is called evanescent light.

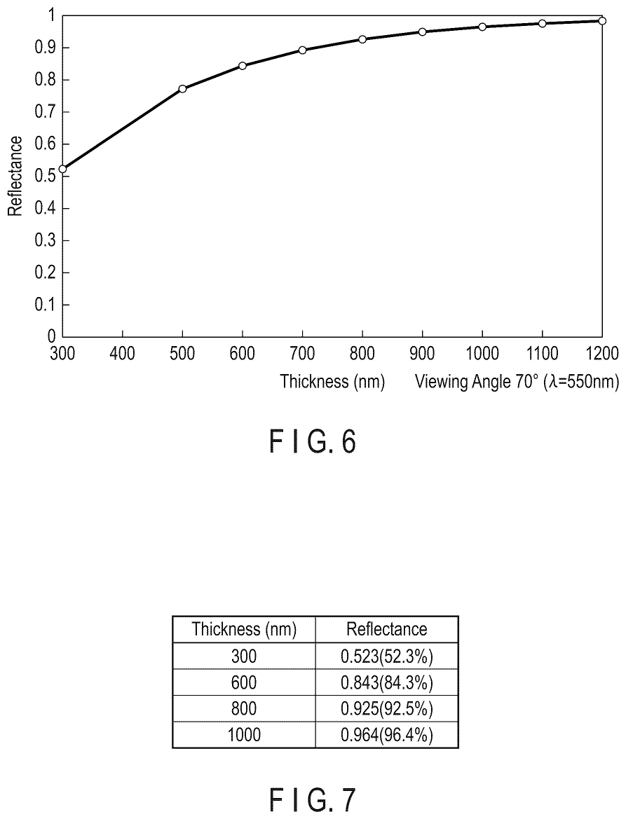

FIG. 6 is a simulation result showing the relationship between thickness and reflectance in a material layer with a low refractive index. In FIG. 6, the horizontal axis indicates a thickness tc ([nm]) of the material layer with low refractive index, and the vertical axis indicates the normalized reflectance. The light used in the simulation is assumed to have a wavelength A of 550 nm and be incident on the material layer of low refractive index at a viewing angle of 70°.

FIG. 7 shows the relationship between the reflectance and the thicknesses when it is 300 nm, 600 nm, 800 nm, and 1000 nm in the simulation results shown in FIG. 6.

In FIG. 7, for example, the transmittance of the transparent layer LRI when its thickness tc is 300 nm and it is incident at a visual angle of around 70° is 48%. When other viewing angle components are considered, there are areas of high and low transmittances, but it is assumed here that over the entire transparent layer LRI, the viewing angle is 70°. The transmittance at this point is set as the transmittance of the entire transparent layer LRI.

As shown in FIGS. 6 and 7, as the thickness of the material layer with low refractive index, that is, the transparent layer LRI, increases, the reflectance increases. In other words, as the thickness of the transparent layer LRI decreases, the reflectance decreases. This is because, when the thickness of the transparent layer LRI is less, the light entering the transparent layer LRI penetrates out as evanescent light, thereby decreasing the reflectance.

However, by utilizing such penetration effect of evanescent light, light can be made to penetrate out in a region far from the light emitting element LD, that is, near the fourth side surface SS4, thereby making it possible to improve the transmittance. On the other hand, in a region close to the light emitting element LD, that is, the region close to the first side surface SS1, light is totally reflected. With this configuration, the amount of light reaching the liquid crystal layer LC of the display panel PNL can be adjusted by the transparent layer LRI.

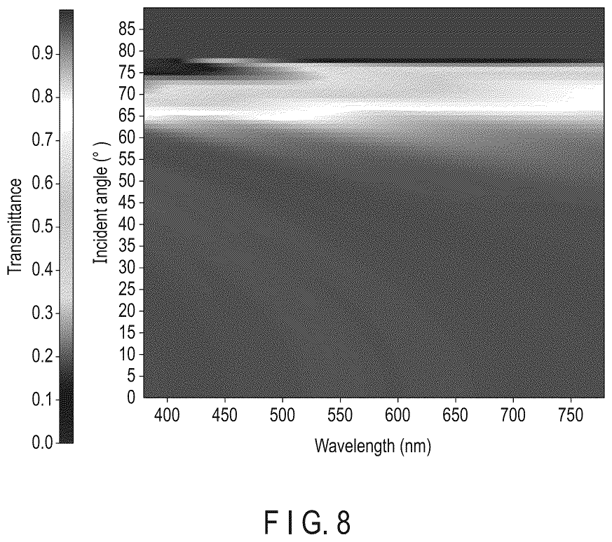

FIG. 8 shows the relationship between the wavelength (λ) of light ([nm]), the incident angle of light ([°]), and the transmittance. The transmittance shown in FIG. 8 is the normalized transmittance, which is the value obtained by subtracting the normalized reflectance from 1 (transmittance=1−reflectance).

FIG. 8 shows that the transmittance is 0.7 (70%) at an angle of incidence of around 70°. In other words, when light enters the transparent layer LRI at an angle of incidence of 70°, the percentage of light reflected is 0.3 (30%), and 0.7 (70%) of the light is transmitted.

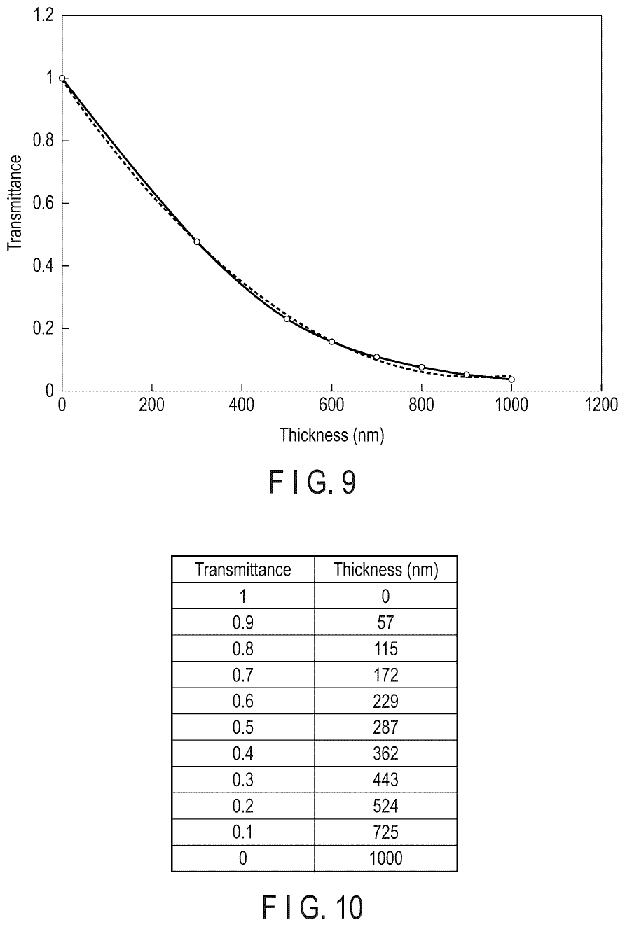

FIG. 9 shows the relationship between the thickness and transmittance of the transparent layer. FIG. 10 shows the relationship between the thickness and transmittance of the transparent layer obtained based on what is shown in FIG. 9. From FIGS. 9 and 10 as well, it can be understood that as the thickness tc of the transparent layer LRI increases, the transmittance decreases, and as the thickness of the transparent layer LRI decreases, the transmittance increases.

As described above with reference to FIGS. 6 to 10, as the thickness tc of the transparent layer LRI increases, the reflectance increases. In other words, as the thickness tc of the transparent layer LRI increases, the transmittance decreases. On the other hand, as the thickness of the transparent layer LRI decreases, the reflectance decreases. In other words, as the thickness of the transparent layer LRI decreases, the transmittance increases.

As discussed above, when the thickness tc of the transparent layer LRI is great in a region close to the light emitting element LD, as in the case of the display device DSP shown in FIG. 4, the reflectance of the transparent layer LRI is higher than the transmittance. Therefore, the amount of light reflected by the transparent layer LRI increases in the region close to the light emitting element LD. In the region close to the light emitting element LD, the transmittance of the transparent layer LRI is smaller, and therefore the amount of light reaching the liquid crystal layer LC of the display panel PNL is less.

On the other hand, when the thickness tc of the transparent layer LRI is less to the region far from the light emitting element LD, the transmittance of the transparent layer LRI is higher than the reflectance. Therefore, in the region far from the light emitting element LD, the amount of light transmitted through the transparent layer LRI is great. Thus, in the region far from the light emitting element LD, the amount of light reaching the liquid crystal layer LC of the display panel PNL is great.

As described above, with the configuration shown in FIG. 4, the light entering the display panel PNL can be adjusted by changing the thickness tc of the transparent layer LRI.

As the thickness tc of the transparent layer LRI changes, a transparent adhesive layer TMS is provided to compensate for the thickness. With this configuration, it is possible to kept the gap between the display panel PNL and the substrate BA3 to be constant.

The thickness tc of the transparent layer LRI should preferably vary continuously, as shown in FIG. 4. However, for manufacturing reasons, it may be difficult to vary the thickness tc continuously in some cases. In such cases, it is an option to vary the thickness tc stepwise.

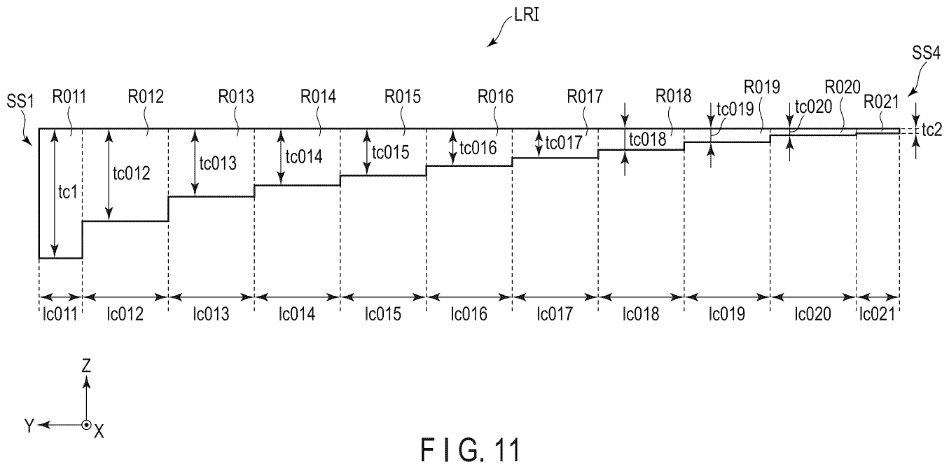

FIG. 11 is a cross-sectional view schematically showing an example of the configuration of the transparent layer. The transparent layer LRI shown in FIG. 11 has thickness stepwise decreasing from the first side surface SS1 towards the fourth side surface SS4. In FIG. 11, the thickness of the transparent layer LRI is varied in eleven steps from the first side surface SS1 to the fourth side surface SS4.

The thickness tc of the transparent layer LRI at the first side surface SS1 is set as a thickness tc1 as described above. Further, the length of a region R011 of the transparent layer LRI, which has the thickness tc1, taken along a direction parallel to the second direction Y is set as a length lc011.

The thickness tc of the transparent layer LRI at the fourth side surface SS4 is set as a thickness tc2 as described above. Further, the length of a region R021 of the transparent layer LRI, which has the thickness tc2, taken along the direction parallel to the second direction Y is set as a length lc021.

From the region R011 to the region R021, a region R012, a region R013, a region R014, a region R015, a region R016, a region R017, a region R018, a region R019, and a region R020 are provided to have thicknesses tc and lengths lc respectively different from each other.

Here, the thicknesses tc of the region R012, region R013, region R014, region R015, region R016, region R017, region R018, region R019, and region R020 are referred to as a thickness tc012, a thickness tc013, a thickness tc014, a thickness tc015, a thickness tc016, a thickness tc017, a thickness tc018, a thickness tc019, and a thickness tc020, respectively.

The lengths lc of the region R012, region R013, region R014, region R015, region R016, region R017, region R018, region R019, and region R020 are referred to as a length lc012, a length lc013, a length lc014, a length lc015, a length lc016, a length lc017, a length lc018, a length lc019, a length lc018, a length lc019, and a length lc020, respectively.

The ratios of the thickness tc011, thickness tc012, thickness tc013, thickness tc014, thickness tc015, thickness tc016, thickness tc017, thickness tc018, thickness tc019, thickness tc020, and thickness tc021, with respect to the whole are set as 5%, 10%, 10%, 10%, 10%, 10%, 10%, 10%, 10%, 10%, and 5%, respectively. As more specific examples, the thickness tc011, thickness tc012, thickness tc013, thickness tc014, thickness tc015, thickness tc016, thickness tc017, thickness tc018, thickness tc019, thickness tc020, and thickness tc021 may be set as 1000 nm, 725 nm, 524 nm, 443 nm, 362 nm, 287 nm, 229 nm, 172 nm, 115 nm, 57 nm, and 0 nm, respectively.

As shown in FIGS. 10 and 11, when from the thicknesses tc011 to tc021 are 1000 nm, 725 nm, 524 nm, 443 nm, 362 nm, 287 nm, 229 nm, 172 nm, 115 nm, 57 nm, 0 nm, respectively, the transmittances of the region R011, region R012, region R013, region R014, region R015, region R016, region R017, region R018, region R019, region R020, and region R021 are 0, 0.1, 0.2, 0.3, 0.4, 0.5, 0.6, 0.7, 0.8, 0.9, and 1.0, respectively.

The ratios of the length lc011, length lc012, length lc013, length lc014, length lc015, length lc016, length lc017, length lc018, length lc019, length lc020, and length lc021 should be determined in a manner similar to the ratio of the thickness lc.

The values and ratios of the lengths lc and the thicknesses tc listed above are only examples and can be changed as needed. They can be changed as appropriate based on the size of the display device DSP, the material of the transparent layer LRI, and the like.

In the transparent adhesive layer TMS, the thickness tk is varied in steps as in the case of the transparent layer LRI. But, as discussed above, the thickness tk of the transparent adhesive layer TMS should be determined so that the sum of the thicknesses of the transparent layer LRI and the transparent adhesive layer TMS becomes constant.

In the display device DSP of this embodiment, the thickness of the transparent layer LRI is reduced as the distance from the light emitting element LD is farther. In the region close to the light emitting element LD, light is reflected by the transparent layer LRI. In the region far from the light emitter LD, the amount of transmitted light increases due to the evanescent light penetration effect. With this configuration, it is possible to make the brightness of the images displayed on the display device DSP to be uniform.

The transparent layer LRI is the so-called solid film, moiré does not occur between the pixel PX, especially the signal line SL and the film. Thus, the display device DSP of this embodiment can not only make the brightness of images uniform, but also suppress the occurrence of moiré.

In this disclosure, the first side surface SS1 and the fourth side surface SS4 may as well be referred to as a first side surface and a second side surface, respectively. The thickness tc of the transparent layer LRI and the thickness tk of the transparent adhesive layer TMS may as well be referred to as a first thickness and a second thickness, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel comprising a first substrate, a second substrate, a liquid crystal layer containing a polymer dispersion liquid crystal;
a plurality of light emitting elements; and
a light guide element,
the light guide element comprising:
a base;
a transparent layer having a refractive index lower than a refractive index of the base; and
a transparent adhesive layer provided to overlap the transparent layer, wherein
the plurality of light emitting elements are arranged adjacent to a first side surface of the base,
a first thickness of the transparent layer decreases from the first side surface towards a second side surface on an opposite side to the first side, and
a second thickness of the transparent adhesive layer increases from the first side surface towards the second side surface.

2. The display device according to claim 1, wherein
a sum of the first thickness and the second thickness is constant from the first side surface to the second side surface.

3. The display device according to claim 1, wherein
the first thickness decreases stepwise from the first side surface to the second side surface.

4. The display device according to claim 1, wherein
the transparent layer is made of a siloxane-based resin or a fluorine-based resin.

5. The display device according to claim 1, wherein
a refractive index of the base is 1.5 and a refractive index of the transparent layer is 1.0 to 1.4.
